(19) United States
(12) Patent Application Publication
(10) Pub. No.: US 2017/0035026 A1
(43) Pub. Date: Feb. 9, 2017

(54) PET TAG WITH LOCATION AND ALARM FUNCTIONS

(71) Applicant: Jiangsu Zhongheng Pet Articles Joint-Stock Co., Ltd., Jiangsu (CN)

(72) Inventor: Qiu Bin, Jiangsu (CN)

(73) Assignee: Jiangsu Zhongheng Pet Articles Joint-Stock Co., Ltd., Jiangsu (CN)

(21) Appl. No.: 15/230,329

(22) Filed: Aug. 5, 2016

(30) Foreign Application Priority Data
Aug. 5, 2015 (CN) 201520584353.0

(51) Int. Cl. A01K 11/00; G09F 3/00

(52) U.S. Cl. CPC A01K 11/008; G09F 3/00; G08B 3/10

(57) ABSTRACT

A pet tag with location and alarm functions includes a cover; a bottom shell; and a circuit board, wherein two convex poles are symmetrically disposed on the bottom shell, and a piece having a threading hole protrudes outwards from an edge of the bottom shell, wherein the circuit board is equipped with an electric horn sound-generating device, a power supply, and a signal transceiving device, wherein two positioning holes corresponding to locations of the convex poles are disposed on the circuit board, wherein the circuit board is installed in the bottom shell through matching of the positioning holes and the convex poles, and wherein the cover covers the bottom shell to accommodate the circuit board therein.

### CROSS-REFERENCE TO RELATED APPLICATIONS

This application claims the priority of Chinese Patent Application No. 201520584353.0, filed on Aug. 5, 2015, the disclosure of which is incorporated by reference in its entirety.

### TECHNICAL FIELD

The present invention relates to pet tags, in particular to pet tags with location and alarm functions.

### BACKGROUND ART

At present, more and more people like to keep pets. Owners take care of their pets carefully. It can be said that food, clothes and other things are all readily available for pets, and owners treat their pets like members of the family or treat them as their children and do their best to take care of them. Pets are very cute regardless cats or dogs, and pets help reduce our stress.

Generally, people raise their pets in captivity to prevent them from getting lost. However, pets, especially cats and dogs, are very lively and active, and more and more owners like to have their pets freely move around at home in order to keep the physical and psychological health of the pets. However, pets have no self-control capability and they often would venture away from safe activity areas. It was really heartbreaking that many cats and dogs are lost every year

### SUMMARY OF THE INVENTION

Embodiments of the present invention are directed to said problem, and an objective of the invention is to provide pet tags with location and alarm functions.

Objects of the present invention may be realized in the following manners:

In accordance with embodiments of the invention, a pet tag with location and alarm functions comprises a bottom shell, a cover, and a circuit board. Two convex poles are symmetrically disposed on the bottom of the bottom shell (on the top face), and a threading hole is disposed on a piece protruding outwards from the edge of the bottom shell. The circuit board may be equipped with an electric horn sound-generating device, a power supply, a signal transceiving device, and two positioning holes corresponding to the locations of the two convex poles. The circuit board is installed in the bottom shell by means of the matching of the positioning holes and the convex poles, and the cover covers the bottom shell and accommodates the circuit board therein.

In accordance with embodiments of the invention, the signal transceiving device may communicate with a user device (e.g., a mobilephone) through Bluetooth, a wireless mode or an infrared mode.

In accordance with embodiments of the invention, the devices may be made waterproof For example, a waterproof ring may also be disposed on a part where the bottom shell is connected with the cover in a covering manner.

In accordance with embodiments of the invention, the bottom shell and the cover may be connected by any suitable means. Such as by the matching of clamping keys and clamping buckles, respectively, disposed on the edge of the bottom shell and the edge of the cover.

In accordance with embodiments of the invention, a corresponding notch may be disposed in a part, where the bottom shell is connected with the cover in a covering manner, to facilitate the opening of the bottom shell and the cover from a covering (closed) state.

In accordance with embodiments of the invention, the power supply may be detachably installed in the device (e.g., on the circuit board). In accordance with embodiments of the invention, the power supplies may be batteries.

In accordance with embodiments of the invention, the bottom shell (2) and the cover (1) may be of any shape (e.g., a bone shape) after being at a covered (closed) state.

Embodiments of the present invention have one or more of the following beneficial effects:

1) A pet tag of the invention is equipped with a signal transceiving device and a electric horn sound-generating device. After a pet uses the pet tag, the electric horn can generate sound to remind an owner once the pet goes out of a safety area; and after the pet is lost, the running distance of the pet can be rapidly calculated through the signal transceiving device, and the pet can be found quickly in cooperation with sound generation of the electric horn.

2) The pet tag is equipped with the waterproof ring in a part where the bottom shell and the cover are connected in a covered manner, so that the waterproofness of the pet tag can be effectively improved.

### BRIEF DESCRIPTION OF THE DRAWINGS

FIG. 1 shows an assembly drawing of one embodiment of the present invention.

FIG. 2 shows an integral external view of one embodiment of the present invention.

### DETAILED DESCRIPTION

The present invention will be further illustrated below with specific examples and the attached drawings.

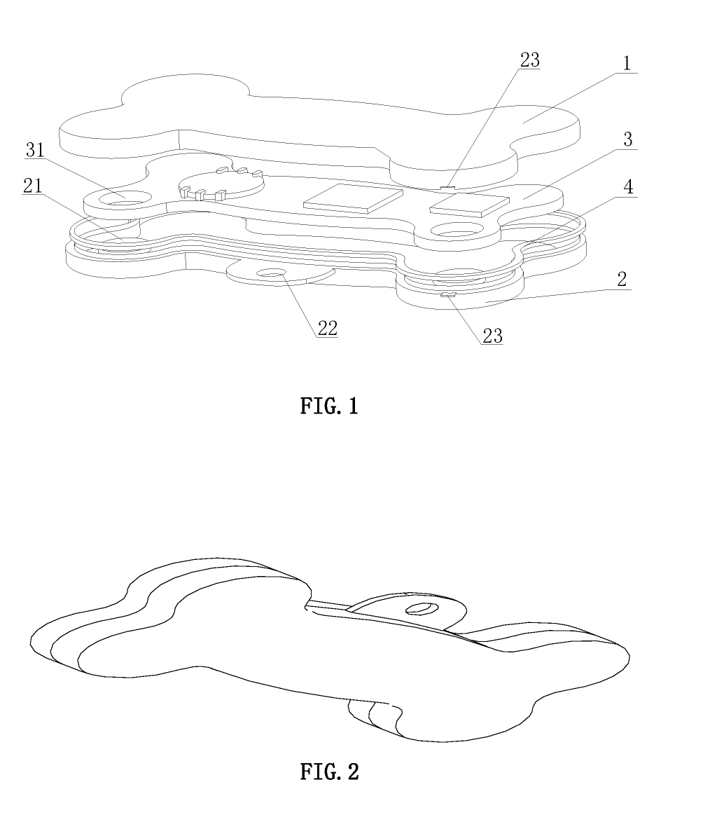

By reference to FIG. 1, in conjunction with FIG. 2, a pet tag with positioning and alarm functions comprises a cover 1, a bottom shell 2, and a circuit board 3, wherein both the cover 1 and the bottom shell 2 may be made of any suitable material (e.g., plastic). Two convex poles 21 are symmetrically disposed on the bottom of the bottom shell 2, and a threading hole 22 protruding outwards is disposed in the edge of the bottom shell 2. The circuit board 3 is equipped with an electric horn sound-generating device, a power supply, and a signal transceiving device, and two positioning holes 31 corresponding to the convex poles 21 are disposed in the circuit board 3. The signal transceiving device may communicate with a mobilephone or a similar device through a Bluetooth mode, a wireless mode or an infrared mode.

The circuit board 3 is installed in the bottom shell 2 through the matching of the positioning holes 31 and the convex poles 21. During assembly, the circuit board 3 can be fixed in the bottom shell 2 conveniently, for example, by melting the convex poles 21. The cover 1 covers the bottom shell 2 and accommodates the circuit board 3 therein. The pet tag at a covering state (i.e., assembled state) may be of any shape (e.g., a bone shape).

In order to enhance the waterproofness of the pet tag, the waterproof ring 4 is also disposed on a part where the bottom shell 2 and the cover 1 are connected in a covering manner.

In order to facilitate to replace the power supply, the bottom shell 2 and the cover 1 are connected by the matching of clamping keys and clamping buckles respectively disposed on the edge of the bottom shell 2 and the edge of the cover 1. The power supply is detachably mounted on the circuit board 3.

In order to further facilitate to open the bottom shell 2 and the cover 1 that are at a covering state together, a corresponding notch 23 is also disposed on a part where the bottom shell 2 and the cover 1 are connected in a covering manner.

The pet tag is generally matched with the mobilephone for use and communicates with the mobilephone through the signal transceiving device. After a pet uses the pet tag, the electric horn can generate sound to remind an owner once the pet goes out of a safety area; and after the pet is lost, the signal transceiving device can calculate the running distance of the pet rapidly and transmit the running distance information to the mobilephone, and it is convenient for owners of pets to find out their pets according to the running information and sound emitted by the electric horn.

What is claimed is:

1. A pet tag with location and alarm functions, comprising,
a cover;
a bottom shell; and
a circuit board,
wherein two convex poles are symmetrically disposed on the bottom shell, and a piece having a threading hole protrudes outwards from an edge of the bottom shell,
wherein the circuit board is equipped with an electric horn sound-generating device, a power supply, and a signal transceiving device,
wherein two positioning holes corresponding to locations of the convex poles are disposed on the circuit board,
wherein the circuit board is installed in the bottom shell through matching of the positioning holes and the convex poles, and
wherein the cover covers the bottom shell to accommodate the circuit board therein.

2. The pet tag with location and alarm functions according to claim 1, wherein the signal transceiving device is configured to communicate with a mobile phone via Bluetooth, via wireless communication or via infrared.

3. The pet tag with location and alarm functions according to claim 1, wherein a waterproof ring is disposed on a part where the bottom shell connects with the cover in a closed state.

4. The pet tag with location and alarm functions according to claim 1, wherein the bottom shell and the cover are connected by matching of a clamping key and a clamping buckle, respectively, disposed on an edge of the bottom shell and an edge of the cover.

5. The pet tag with location and alarm functions according to claim 1, wherein a corresponding notch is disposed in a part, where the bottom shell connects with the cover in a covered manner, to facilitate opening of the bottom shell and the cover from a closed state.

6. The pet tag with location and alarm functions according to claim 1, wherein the power supply is detachably installed on the circuit board.

7. The pet tag with location and alarm functions according to claim 1, wherein the bottom shell and the cover are of a bone shape in a covered state.
